(19) United States
(12) Patent Application Publication
(10) Pub. No.: US 2009/0304387 A1
(43) Pub. Date: Dec. 10, 2009

(54) OPTICAL DATA NETWORK FOR BILATERAL COMMUNICATION BETWEEN A PLURALITY OF COMMUNICATION NODES

(75) Inventors: Mark Cunningham FARRIES, Exeter (GB); Bruce Robertson NAPIER, Paderborn (DE)

Correspondence Address: PATENTS ON DEMAND - G&H, 4581 WESTON ROAD, SUITE 345, WESTON, FL, 33331, US

(73) Assignee: GOOCH & HOUSEGO PLC, SOMERSET (GB)

(21) Appl. No.: 12/477,607

(22) Filed: Jun. 3, 2009

Related U.S. Application Data
(60) Provisional application No. 61/058,638, filed on Jun. 4, 2008.

(51) Int. Cl. H04J 14/00

(52) U.S. Cl. 398/67

(57) ABSTRACT

A fiber optic bidirectional communications network includes a plurality of decentralized communication nodes each including a receiver for receiving electromagnetic radiation at a wavelength λ₂ and a transmitter for transmitting electromagnetic radiation at a wavelength λ₁, at least one relay including a receiver operable to receive signals at λ₂ and a transmitter for transmitting signals at λ₂. At least one passive optical network (PON) includes at least one optical fiber, at least bidirectional coupler coupled to the optical fiber for coupling signals at λ₂ transmitted by the relay to the plurality of communication nodes and for combining signals at λ₁ from the plurality of nodes into the optical fiber for coupling to the relay. Any of the plurality of communication nodes may communicate of the other communication nodes via the relay. In one embodiment λ₁≠λ₂ and the relay is a wavelength shifting relay.

### CROSS REFERENCE TO RELATED APPLICATIONS

This application claims the benefit of Provisional Application Ser. No. 61/058,638 entitled “OPTICAL DATA BUS FOR BILATERAL COMMUNICATIONS BETWEEN A PLURALITY OF NODES”, filed Jun. 4, 2008, which is herein incorporated by reference in its entirety.

### FIELD OF INVENTION

Embodiments of the invention relate to fiber optic network communications for bilaterally communicating data among a plurality of communication nodes, including embodiments where the plurality of nodes are interface to an electrical network.

### BACKGROUND

Conventional data busses utilize electrical wires to transfer data between the different subsystems (e.g., nodes) on the bus. This interconnection via electrical wires results in several disadvantages. The electrical wires require an electrical connection to the subsystem which either involves an electrical connector or more permanent attachment such as a terminal screw post or soldered joint. Applications that require the removal of a subsystem from the data bus generally use electrical connectors which are susceptible to physical damage and can experience failure. Additional time is often needed to perform the electrical connection and route the electrical wires of the data bus around the subsystems. The presence of the interconnecting electrical wires between the subsystems places a constraint on the locations and accessibility of the subsystems.

For the purpose of chip-to-chip, board-to-board, and system-to-system communications over high bandwidth distance links, the use of optical interconnection networks as replacements for their electrical counterparts is steadily growing. For links of high bit rate and distance (for example, greater than 10 meter-gigabits per second), optical transmission technology is increasingly providing better cost and performance versus electrical transmission technology. An additional advantage of optical transmission technology is that it can provide multi-point links without a significant reduction in performance.

Multi-drop and multi-point links are particularly useful in computer and communications systems with many integrated processing units, such as for Symmetric Multi-processor (SMP) buses, memory buses, and I/O buses in high-end systems, since such links allow close coupling between multiple different devices without multiple separate point-to-point links. For example, busses are commonly used on aircraft for transmitting avionic data between instruments. A known optical equivalent for the multipoint link is an “optical star coupler” which can be used for an optical network, such as defined in MIL-STD-1773 fiber optic data bus interface modules. In an optical star coupler, optical data streams from each of the inputs are combined in the star coupler and physically distributed to all of the outputs, so that each input can (with appropriate arbitration for access) broadcast data to all of the outputs. These optical star coupler networks are created through the integration of devices that perform functions such as beam-splitting, “fan-in”, “fan-out”, and coupling.

However, star couplers are known to have some significant disadvantages that can make them unsatisfactory for certain applications. For example, star couplers generally require a significant amount of fiber to implement since they require two separate fibers per node (one fiber for downstream communications and a separate fiber for upstream communications), making implementation generally expensive. Operation is also currently limited to large diameter multi-mode (200/280 μm) fiber. Such large diameter fiber is not compatible with narrow band laser sources that are generally used in wavelength multiplexed systems that enable multiple networks to be integrated star couplers. Moreover, star couplers are generally unable to integrate with other optical networks, absent optical-electrical-optical (OEO) conversion at one or more of the nodes. Finally, star couplers tend to be quite lossy and suffer significant crosstalk problems.

### SUMMARY

This Summary is provided to comply with 37 C.F.R. § 1.73, presenting a summary of the invention to briefly indicate the nature and substance of the invention. It is submitted with the understanding that it will not be used to interpret or limit the scope or meaning of the claims.

Embodiments of the invention described fiber optic bidirectional communication networks comprising a plurality of decentralized communication nodes that permit the communication nodes to communicate with any other node or combination of other nodes. The network comprises a plurality of communication nodes each comprising a transceiver, a relay comprising a transceiver, and a passive optical network (PON) that includes a bidirectional coupler (e.g., fused fiber coupler) for coupling signals transmitted by the relay to the plurality of communication nodes and for combining signals received from the plurality of communications nodes coupling to the relay. The transceiver is generally used to boost the signal level to increase the available power budget. By including two or more PONS, dual bus operation can be realized. The transceivers can be wavelength shifting transceivers which can combine the upstream and downstream signals in a single fiber for bidirectional communications.

In contrast, in conventional fiber optic communications networks, such as star couplers described above, each communication node can only communicate bidirectionally with a common switching center or exchange. In addition, conventional fiber optic communications networks require two fibers per node (one for upstream and one for downstream communications) making implementation generally expensive. Star coupler operation is also currently limited to multi-mode fiber, which are not generally compatible with the narrow band “fiber” laser sources that are generally used in wavelength multiplexed systems that enable multiple networks to be integrated star couplers. Moreover, star couplers are generally unable to integrate with other optical networks, absent optical-electrical-optical (OEO) conversion at one or more of the nodes.

### BRIEF DESCRIPTION OF THE DRAWINGS

FIG. 1A is a simplified depiction of a fiber optic bidirectional communications network according to an embodiment of the invention.

FIG. 1B is a simplified depiction of a fiber optic bidirectional communications network including a PON according to an embodiment of the invention embodied for replacing the MIL-STD electrical bus in a MIL-STD-1553 network.

FIG. 2 is a drawing depicting the conversion of an electrical network comprising a plurality of nodes/modules to an optical network.

FIG. 3 is an avionics block diagram for a Weapons Replaceable Assemblies (WRA)-based system including a fiber optic bidirectional communications network according to an embodiment of the invention for providing the high speed data bus for the system.

### DETAILED DESCRIPTION

Embodiments of the invention are described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. Embodiments of the invention are not limited by the illustrated ordering of acts or events, as some acts may occur in different orders and/or concurrently with other acts or events. Furthermore, not all illustrated acts or events are required to implement a methodology in accordance with embodiments of the invention.

In the context of embodiments of the invention the term “optical” when used herein can apply to any and all forms of electromagnetic radiation, including, but not limited to infrared (IR) and visible light. In addition, as used herein, a “passive network”, such as in a “passive optical network” (or PON) is a network that is operable without any externally supplied power.

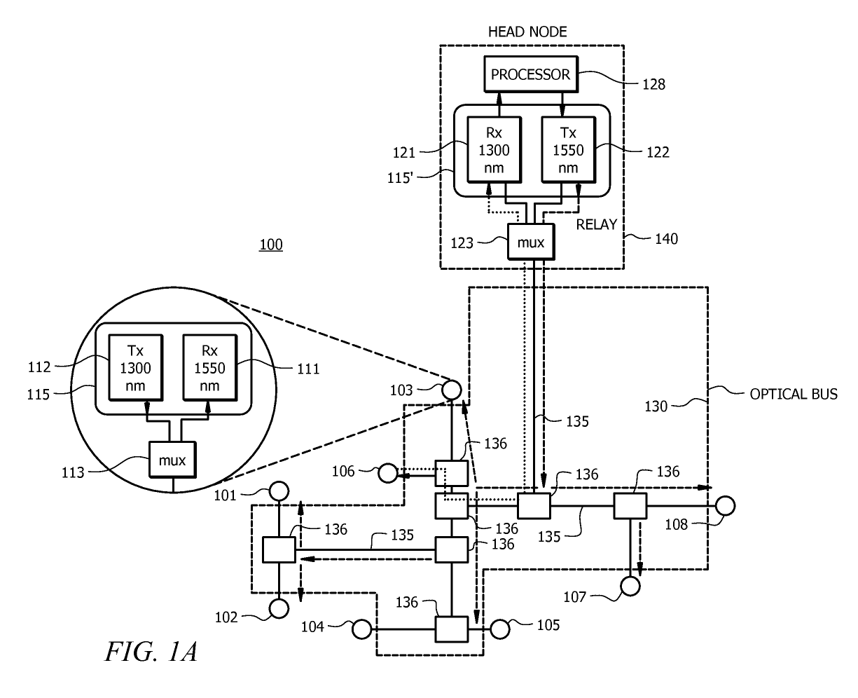

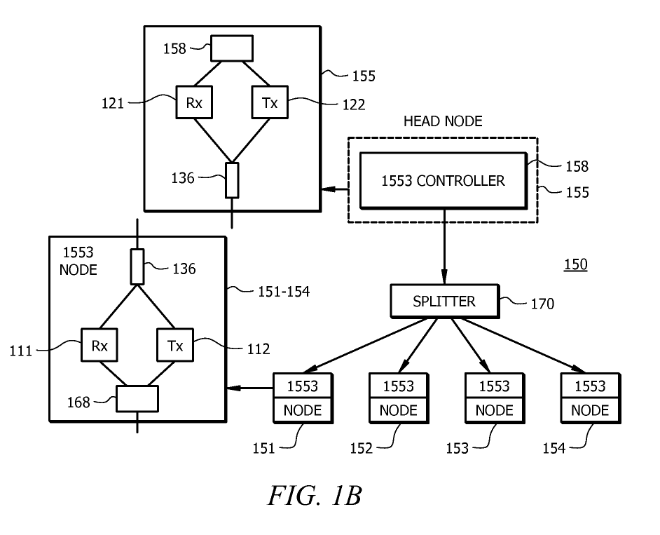

Referring to FIG. 1A, a fiber optic bidirectional communications network 100 according to an embodiment of the invention is shown. The network 100 comprises a plurality of decentralized communication nodes 101-108, a relay 140, and a passive optical network (PON) 130 that includes bidirectional couplers 136 (e.g., fused fiber coupler) for coupling signals transmitted by the relay 140 to the plurality of communication nodes 101-108 and for combining signals received from the plurality of communications nodes 101-108 for coupling to the relay 140. In network 100, signals at two different wavelengths (λ₁≠λ₂, shown as one particular set of wavelengths λ₁=1300 nm and λ2=1550 nm) are combined in a single fiber 135 throughout network 100 for bi-directional communications throughout the network 100. As noted above, although embodiments of the invention are generally described with the upstream (towards relay 140) and downstream (toward communications nodes 101-108) signals being at two different wavelengths (λ₁≠λ₂), for certain protocols the wavelengths for the upstream and downstream signals can also be equal (λ₁=λ₂). For embodiments when λ₁≠λ₂, embodiments of the invention can be operated at different wavelengths as compared to those described relative to FIG. 1A. Moreover, in one embodiment the wavelengths transmitted at one or more of the various communication nodes 101-108 can be different.

The plurality of decentralized communication nodes 101-108 are shown in FIG. 1 arranged in a network tree arrangement. Each of the plurality of communication nodes 101-108 comprise a transceiver 115 comprising a photodetector/receiver 111 (referred to herein as receiver 111) for receiving electromagnetic radiation at a wavelength λ₂ shown as 1550 nm and a transmitter (e.g., a laser) 112 for transmitting electromagnetic radiation at a wavelength λ₁ shown as 1300 nm, and a multiplexer (mux) 113 coupled to an input of receiver 111 and to an output of transmitter 112. Mux 113 can comprise a fused coupler.

At least one relay 140 is provided. The relay 140 is shown at a separate node at the top of the network tree and thus can be referred to as a “head node”. Relay 140 comprises a transceiver 115′ comprising a receiver 121 operable to receive signals at λ₁, a transmitter 122 for transmitting signals at λ₂, and a mux 123 for allowing fiber 135 to interface with both receiver 121 and transmitter 122. Mux 123 can comprise a fused coupler. In the case shown where λ₁≠λ₂, relay 140 generally comprises a wavelength shifting relay.

The transmitter 122 can be used to boost the signal level (relative to the signal level received) and thus increase the available power budget and as a result the number of nodes that may be serviced in network 100. In one embodiment, transceiver 115′ operates at a fixed (constant) power level, such as 1 to 5 mW for networks having approximately 10 to 50 nodes.

Relay 140 is shown including an optional processor 128, such as a microprocessor. A microprocessor can provide dynamic power control for transmitter 122 and also protocol or encoding functions that are generally required when interfacing to other networks (optical or electrical). A processor can also provide self-testing for network 100 including self-testing of relay 140. Processor 128 can also provide signal regeneration in order to reduce noise, pulse spreading and timing errors that are known to occur in transmission systems.

Network 100 includes at least one passive optical network (PON) 130. PON 130 comprises at least one optical fiber 135. Fiber 135 can be made from a variety of materials, such as glass (e.g., silica) or certain polymers. Unlike conventional star couplers that require multimode fiber, fiber 135 can be a single mode or a multimode fiber. PON 130 also comprises at least bidirectional coupler 136 coupled to the fiber 135 for coupling the signals at λ₂ transmitted by relay 140 to the plurality of communication nodes 101-108 and for combining the signals at λ₁ from the plurality of communication nodes 101-108 into the fiber 135 for coupling to the relay 140. Although only a single PON 130 is shown in FIG. 1A, network 100 can comprise a plurality of PONs 130, such as for supporting a plurality of busses. For example, dual bus operation can be realized by installing two PONS.

In network 100 any of the plurality of communication nodes 101-108 may communicate with any other of the plurality of communication nodes 101-108 via relay 140. In FIG. 1A, data communications from node 106 at λ₁=1300 nm is shown reaching relay 140. Relay 140 is shown as a wavelength shifting relay retransmitting the data received from node 106 at λ₂=1550 nm to all of the other communication nodes 101-108 in network 100.

As described above, communication nodes 101-108 also each include a multiplexer (mux) 123 for allowing fiber 135 to interface with both receiver 111 and transmitter 112. The mux 123 can also be embodied as a splitter, and thus need not be wavelength sensitive, particularly when relatively high power is available due to increased lossiness (3 dB) generally associated with operation of a conventional splitter.

PON 130 as shown in FIG. 1A comprising only passive optics. Bidirectional couplers 136 that can comprise a conventional 3 dB coupler at each split in the PON 130. The couplers 136 can be fused fiber couplers (e.g., 1300/1550 nm fused couplers) which are bi-directional devices, or alternatively the splitters can be implemented as planar waveguides or dielectric filter devices. Ignoring the generally negligible excess loss in these devices, the downstream the signal from relay 140 is split between the communication nodes 101-108 efficiently, all the communication nodes 101-108 getting a substantially equal share (⅛th for eight nodes) of the signal power provided by relay 140. On the upstream route, half of the signal (3 dB) is generally lost at each split when the bidirectional coupler 136 comprises a conventional 3 dB coupler. Bidirectional couplers 136 may also generally be embodied as non-equal power splitters (e.g., 25%/75%), and multi-port splitters (1×3, 1×N), etc.

Although not shown in FIG. 1A, relay 140 can also be coupled to other optical or electrical networks. For example, in the case of another optical network, an optical signal from relay 140 can be transported over one or more other fiber networks, such as by wavelength division multiplexing (WDM) with other signals including avionics full duplex (AFDX) data.

Although not shown in FIG. 1A, a bus controller (e.g., interface circuit) can be included in the network 100. Optional processor 128 shown in FIG. 1 can provide the bus controller function. For example, the bus controller can be co-located with relay 140 at the head node as shown in FIG. 1A. The bus controller can also be co-located at any of the plurality of communication nodes 101-108, or alternatively, at a separate dedicated bus controller node.

For interfacing to networks having a 2-state protocol, the Tx and Rx at relay 140 and at the communication nodes 101-108 do not generally require an interface circuit. However, a 2-state protocol system according to an embodiment of the invention can include interface circuits such as for protocol shifting or encoding/decoding.

For interfacing to networks having 3-state protocols, e.g., MIL-STD-1553 or the civil CANbus, some interface circuitry is included in network 100. MIL-STD-1553 is a Digital Time Division Command/Response Multiplex Data Bus. For 3-state protocols such as MIL-STD-1553 an interface circuit is generally used at each communication node 101-108 in-order to convert between 3-state signals and 2-state signals (bi-state). However, for interfacing to networks having 3-state protocols the relay 140 will not generally require an interface circuit in embodiments where the relay 140 merely passes the 2-state data received from the communication nodes 101-108 through. Accordingly, the only modification of the MIL-STN-1553 protocol signals generally needed for integrating a communications bus according to an embodiment of the invention to a MILSTD-1553 or the civil CANbus network is the conversion of tri-state data to bi-state data and back again, which can be done by several known techniques, such as frequency shift keying, simple binary encoding, etc.

FIG. 1B is a simplified depiction of a fiber optic bidirectional communications network 150 including a PON according to an embodiment of the invention embodied for replacing the MIL-STD electrical bus in a MIL-STD-1553 network. Network 150 comprises a head node 155 having a bus controller 158 shown as a 1553 controller coupled to communication nodes 151-154 via splitter 170. The depiction provided is not a generic solution for a MIL-STD-1553 network, and is thus only one exemplary embodiment. For example, the bus controller 158 need not be at the head node 155 as shown in FIG. 1B, such as positioned at any of the communication nodes 151-154.

Controller 158 comprises a fused coupler 136, detector/receiver 121, transmitter 122 and interface circuit 158. Interface circuitry 158 generally comprises a processor (e.g., microprocessor) for providing protocol conversion as needed and other functions (e.g., encoding) to provide a virtual link to one or more nodes in another network (e.g., 1553 network).

Communication nodes 151-154 comprise a fused coupler 136, detector/receiver 111, transmitter 112 and interface circuit 168. Interface circuit 168 provides protocol conversion as needed and other functions (e.g., encoding) to provide a virtual link to one or more nodes in another network (e.g., 1553 network).

Embodiments of the invention can use a variety of methodologies to control communications over the bus or busses. Analogous to methodologies used for star-coupled data buses, one methodology that can be used can be based on a token, which is a series of data bits that comprise a specific data word that is passed between the respective nodes. The node that currently holds the token that is the node that was directed to receive and hang onto the token, is the only node that can transmit data onto the data bus. Token passing prevents bus contention, which occurs when more than one communication node attempts to transmit on the data bus at the same time. The composition of the token is not generally constrained by the physical configuration or the data bus.

Another protocol used on a conventional star-coupled data bus that can generally be used with embodiments of the invention is one which allocates a specific interval of time (analogous to time division multiplexing (TDM)) in which each communication node can transmit its data on the data bus, and wherein each communication node is assigned its own unique time interval so that bus contention is prevented. Protocol formats, such as Asynchronous Transfer Mode are enabling a wide range of data types, including voice and video images, to be transmitted across the country on optical fiber to thousands of users via the Synchronous Optical Network.

Timing on data buses according to embodiments of the invention can be achieved in a wide variety of ways. For example, as known in the art, timing on the bus can be achieved by extracting a clock signal from the encoded data. For example, several approaches are known in the art to encode data that enable extraction of the clock. MIL-STD-1553 and MIL-STD-1773 use a data encoding code referred to as Manchester that introduces a clock transition into every data bit. Non-return-to-zero is also known. The Fiber Distributed Data Interface is a commercial fiber optic data bus that uses straight nonreturn-to-zero data transmission with an encoding called 4B/5B. This code encodes every 4 bits of data into 5 bits and thereby insures that even when a string of zeros or ones is transmitted there will be enough transitions occurring in the data stream to extract the clock. FiberChannel is another commercial standard that recovers the clock in a similar way from data encoded using 8B/10B.

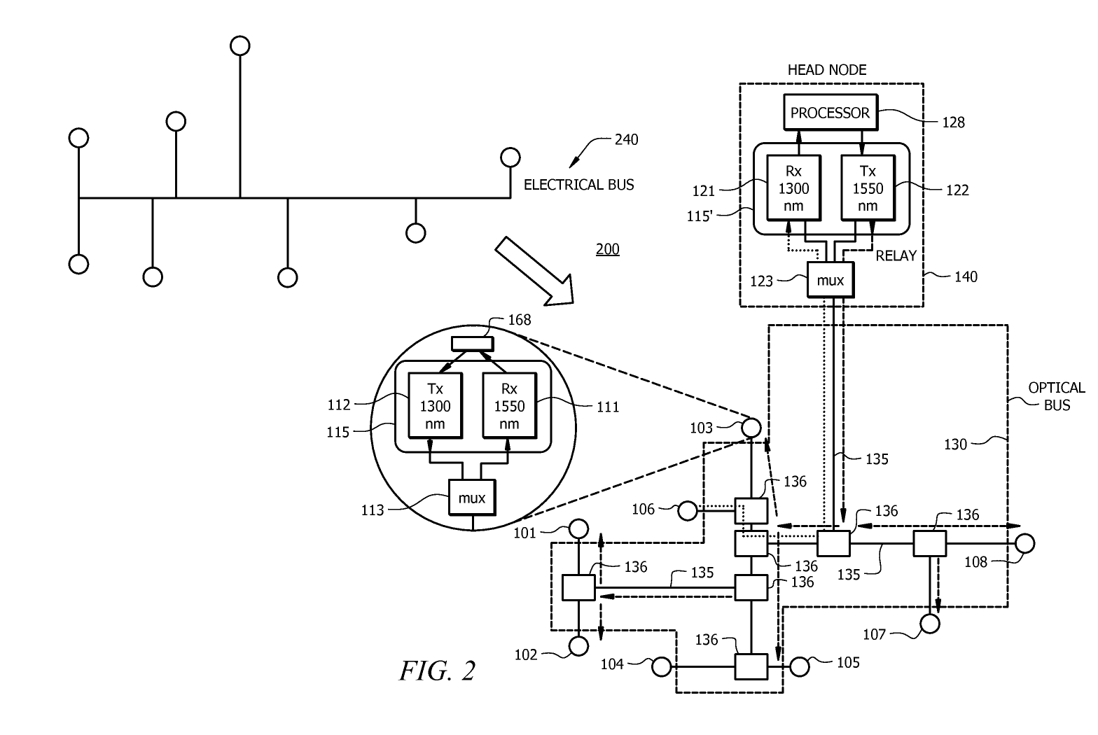

FIG. 2 is a drawing depicting the conversion of an electrical network comprising a plurality of nodes/modules 240 to an optical network 200 according to an embodiment of the invention. Optical network 200 can comprise an optical network such as network 100 shown in FIG. 1A with interface circuits added at the communication nodes, such as interface circuit 168 described relative to FIG. 1B, according to an embodiment of the invention. Optical network 200 can be used to replace an electrical data bus (e.g. MIL-STD-1553) with an optical data bus.

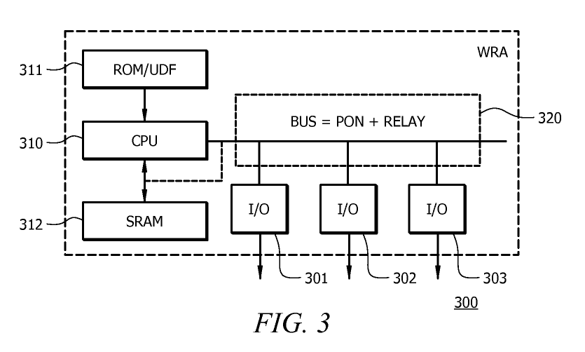

Fiber optic bidirectional communications networks according to an embodiment of the invention can benefit a wide variety of systems that need high speed data exchange between a plurality of components, such as computer components which perform certain processing functions. FIG. 3 is an avionics block diagram for a Weapons Replaceable Assemblies (WRA)-based system 300 including a fiber optic bidirectional communications network 320 according to an embodiment of the invention for providing a high speed optical data bus for the WRA system. The avionics systems on aircraft frequently comprises general purpose computer components which perform certain processing functions, then relay this information to other system components. Some common examples are the mission computers, radar processors, radar warning receivers (RWRs), and jammers.

An optical data bus according to an embodiment of the invention 320 comprising a PON (e.g., PON 130 shown in FIG. 1A) and a relay (e.g., relay 140 shown in FIG. 1A) is shown providing communications between a CPU 310 and a plurality of input/output (I/O) modules/nodes 301, 302 and 303. A ROM/Universal Disk Format (UDF) 311 and SRAM 312 are shown coupled to CPU 310. Although not shown, interface circuitry is generally provided for converting between optical and electrical signals for coupling to the CPU 310. Interface circuitry is also generally provided in the I/O nodes 301-303, but could also be included in the bus.

The I/O modules/nodes 301-303 will generally vary in function, but will all generally serve the same purpose to translate the electrical signals from one protocol to another in order to exchange information. I/O modules are used similarly in general purpose computers in laboratories to test equipment and/or tie computers together via a local area network (LAN) to exchange information. The high speed data busses on avionics/computers do not generally operate as fast as the CPU clock speed, but they are generally much faster than the interface busses they connect to. There are a number of interface busses which are widely used by aircraft, avionics systems and test equipment. The most common include the RS-232, the RS-422, the RS-485, the IEEE-488 (GP-IB/HP-IB) and the MIL-STD-1553A/B. The MIL-STD-1773 bus is a fiber optic implementation of the 1553 bus using conventional star couplers which can be implemented with optical data busses according to embodiments of the invention, such as shown in FIG. 2.

Other possible protocols supportable by an appropriate protocol module that can generally be used with embodiments of the invention include, but are not limited to, IEEE-488.1 and IEEE-488.2 (general purpose interface), IEEE-802.3 (Local Area Network and Ethernet standards), ISO 11898-2 (CAN high-speed standard), ISO 11898-3 (CAN fault-tolerant (low-speed) standard), ISO 11992-1 (CAN fault-tolerant standard for truck/trailer communication), ISO 11783-2 (250 kbit/s, Agricultural Standard), SAE J1939-11 (250 kbit/s, Shielded Twisted Pair (STP) standard), SAE J1939-15 (250 kbit/s, UnShielded Twisted Pair (UTP) reduced layer standard), and the SAE J2411 (Single-Wire CAN (S WC) standard).

The list of protocol standards in the preceding paragraphs is given only as an example, and is not intended to circumscribe a finite population to limit the scope of any of the many embodiments of the invention. Any combination of the above protocol standards may be included within a protocol firmware module, and additional protocol standards not listed above but known to those skilled in the relevant art may also be incorporated in a universal controller within the scope of the invention.

The breadth and scope of embodiments of the invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including,” “includes,” “having,” “has,” “with,” or variants thereof are used in either the detailed description and/or the claims, such terms are intended to be inclusive in a manner similar to the term “comprising.”

We claim:

1. A fiber optic bidirectional communications network, comprising:
a plurality of decentralized communication nodes each comprising a receiver for receiving electromagnetic radiation at a wavelength λ₂ and a transmitter for transmitting electromagnetic radiation at a wavelength λ₁;
at least one relay comprising a receiver operable to receive signals at said λ₁ and a transmitter for transmitting signals at said λ₂, and
at least one passive optical network (PON) comprising at least one optical fiber and at least one bidirectional coupler coupled to said fiber for coupling said signals at said λ₂ transmitted by said relay to said plurality of communication nodes and for combining said signals at said λ₁ from said plurality of communication nodes into said optical fiber for coupling to said relay;
wherein any of said plurality of nodes may communicate with any other of said plurality of nodes via said relay.

2. The fiber optic network of claim 1, wherein said λ₁≠said λ₂ and said relay comprises a wavelength shifting relay.

3. The fiber optic network of claim 1, wherein said λ₁=said λ₂.

4. The fiber optic network of claim 1, wherein said λ₁ and said λ₂ are both combined in said optical fiber, and said optical fiber is a single mode fiber.

5. The fiber optic network of claim 1, wherein said optical network further comprises at least one processor for protocol or encoding shifting.

6. The fiber optic network of claim 1, wherein at least a portion of said plurality of communication nodes further comprise an interface circuit, said interface circuit for interfacing to an electrical network having a protocol.

7. The fiber optic network of claim 6, wherein said protocol of electrical network comprises a tri-state protocol.

8. The fiber optic network of claim 7, wherein said tri-state protocol comprises MIL-STD-1553 or CANbus.

9. The fiber optic network of claim 6, wherein said interface circuit is co-located with said relay.

10. The fiber optic network of claim 6, wherein said interface circuit is located at a node separate from said plurality of communication nodes and said relay.

11. The fiber optic network of claim 1, wherein said relay provides amplification, wherein a power output provided by said relay is greater than a power received at said relay.

12. The fiber optic network of claim 1, wherein said relay is coupled to another electrical or optical network.

13. The fiber optic network of claim 1, wherein said at least one PON comprises a plurality of said PONs.

14. The fiber optic network of claim 1, further comprising a head node at a top of said network, wherein said relay is located at said head node.

15. The optical fiber network of claim 1 at least a portion of said PON is shared with another network by wavelength multiplexing signals at wavelengths different from said λ₁ and said λ₂.

16. A method of optically communicating data between a plurality of nodes coupled to a fiber optic communications network, said network including a relay, comprising:
transmitting a first optical signal comprising data from a first node of said plurality of nodes at a wavelength λ₁ into said network;
receiving said first optical signal at said relay;
retransmitting a second optical signal comprising said data at a wavelength λ₂ into said network, and
receiving said second optical signal at one or more of said plurality of nodes including said plurality of nodes other than said first node.

17. The method of claim 16, wherein said relay comprises a wavelength shifting relay and said λ₁≠said λ₂.

18. The method of claim 16, further comprising receiving an electrical signal including said data at said first node before said transmitting.

19. The method of claim 16, wherein said fiber optic communications network consists essentially of at least one passive optical network (PON) comprising at least one optical fiber, at least one bidirectional coupler coupled to said fiber for coupling said second optical signal transmitted by said relay to said plurality of nodes and for combining said first optical signal from said plurality of nodes into said fiber for coupling to said relay.

20. The method of claim 16, wherein said relay is coupled to another electrical or optical network.

21. A fiber optic bidirectional communications network, comprising:
a plurality of decentralized communication nodes each comprising a receiver for receiving electromagnetic radiation at a wavelength λ₂ and a transmitter for transmitting electromagnetic radiation at a different wavelength λ₁;
at least one wavelength shifting relay comprising a receiver operable to receive signals at said λ₁ and a transmitter for transmitting signals at said λ₂, and
at least one passive optical network (PON) comprising at least one fiber wherein said λ₁ and said λ₂ are both combined in said at least one optical fiber, and a bidirectional coupler coupled to said optical fiber for coupling said signals at said λ₂ transmitted by said relay to said plurality of communication nodes and for combining said signals at said λ₁ from said plurality of communication nodes into said optical fiber for coupling to said relay;
wherein any of said plurality of nodes may communicate with any other of said plurality of nodes via said relay.

22. The fiber optic network of claim 21, wherein said optical fiber is a single mode fiber and said bidirectional coupler comprises a fused fiber coupler.
